(19) United States
(12) Patent Application Publication
(10) Pub. No.: US 2014/0030174 A1
(43) Pub. Date: Jan. 30, 2014

(54) SYSTEM AND METHOD FOR CONVEYING SOLIDS

(71) Applicant: Thomas Frederick Leininger, Chino Hills, CA (US)

(72) Inventor: Thomas Frederick Leininger, Chino Hills, CA (US)

(73) Assignee: General Electric Company, Schenectady, NY (US)

(21) Appl. No.: 13/560,957

(22) Filed: Jul. 27, 2012

(51) Int. Cl. B01D 53/00; B01D 53/18

(52) U.S. Cl. 423/210; 422/612; 422/624; 422/608

(57) ABSTRACT

A system includes a first reactor configured to receive a first gaseous stream and generate a first solids stream, a second reactor configured to receive the first solids stream, receive a second gaseous stream, and generate a second solids stream, and a solids pressurizing feeder configured to convey the first solids stream or the second solids stream. The solids pressurizing feeder is configured to at least substantially reduce or prevent fluid flow between the first reactor and the second reactor.

### BACKGROUND OF THE INVENTION

The subject matter disclosed herein relates to conveying solids, and, more particularly, to conveying solids in the presence of fluids.

Various industrial processes include the conveying of solids in the presence of fluids, which may be gases or liquids. For example, solids may be conveyed to a fluidized bed reactor in which the fluid is passed through the solid material at high enough velocities to suspend the solid and cause it to behave as if it were a fluid. An integrated gasification combined cycle (IGCC) power plant may include a desulfurization system that uses fluidized bed reactors. A fluid catalytic cracking unit (FCCU) found in many refineries may also include fluidized bed reactors. Two or more fluidized bed reactors may be coupled together in such systems in a manner that allows the solids to circulate continuously between the two or more fluidized bed reactors. In systems such as these, the fluids used in each of the coupled fluidized bed reactors may be different from one another and it may be desirable to help prevent the different fluids from contacting or mixing with each other. For example, it may be desirable to help prevent a combustible gas from contacting or mixing with an oxygen-rich gas because the two gases may form a flammable or combustible mixture. Furthermore, in still other applications employing coupled fluidized bed reactors, it may be desirable to help prevent the contamination of one fluid by another, which may affect product quality. Unfortunately, it may be difficult to convey solids from one fluidized bed reactor to another without mixing of the fluids between the reactors. When coupling two fluidized beds for circulating solids between them, the solids may be conveyed from one bed to the other in conduits that are generally oriented vertically. When the solids are conveyed from a fluidized bed at a higher elevation to one at a lower elevation, the solids may be allowed to move downward through the conduit under the influence of gravity. When the solids are conveyed from a fluidized bed at a lower elevation to one at a higher elevation, the solids may be entrained in an upwardly flowing carrier gas that may or may not be the same as one of the fluids in either one of the fluidized beds. Using these methods of conveying the solids between the coupled beds, the operating pressures of the coupled fluidized bed reactors may be limited to being approximately the same as one another, which may limit the performance of one or both reactors. Furthermore, any disturbances in pressure or flow rate occurring upstream or downstream of either of the fluidized beds may upset the delicate pressure balance around the system to the point where unwanted flows of solids or fluids or both may occur, and this may lead to unwanted contact and mixing of the contents of the two fluidized beds.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a desulfurizer configured to receive a gaseous stream. The desulfurizer includes a sulfur absorption material configured to absorb a sulfur compound from the gaseous stream to generate a saturated sulfur absorption material and a product stream substantially free of the sulfur compound. The system also includes a regenerator configured to receive the saturated sulfur absorption material from the desulfurizer. The regenerator is configured to regenerate the saturated sulfur absorption material to generate a regenerated sulfur absorption material and sulfur dioxide. The system also includes a solids pressurizing feeder configured to convey the sulfur absorption material, the saturated sulfur absorption material, or the regenerated sulfur absorption material. The solids pressurizing feeder is configured to at least substantially reduce or prevent fluid flow between the desulfurizer and the regenerator.

In a second embodiment, a system includes a first reactor configured to receive a first gaseous stream and generate a first solids stream, a second reactor configured to receive the first solids stream, receive a second gaseous stream, and generate a second solids stream, and a solids pressurizing feeder configured to convey the first solids stream or the second solids stream. The solids pressurizing feeder is configured to at least substantially reduce or prevent fluid flow between the first reactor and the second reactor.

In a third embodiment, a method includes receiving a first gaseous stream at a first reactor, generating a first solids stream at the first reactor, receiving the first solids stream at a second reactor, receiving a second gaseous stream at the second reactor, generating a second solids stream at the second reactor, conveying the first solids stream or the second solids stream using a solids pressurizing feeder, and substantially reducing or preventing fluid flow between the first reactor and the second reactor using the solids pressurizing feeder.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a multi-reactor system that may employ a solids pressurizing feeder between reactors;

FIG. 2 is a schematic diagram of an embodiment of a sulfur removal system that may employ a solids pressurizing feeder;

FIG. 3 is a schematic diagram of an embodiment of a sulfur removal system that may employ two solids pressurizing feeders;

FIG. 4 is a schematic diagram of an embodiment of a sulfur removal system that may employ three solids pressurizing feeders;

FIG. 5 is a schematic diagram of an embodiment of a fluid catalytic cracking unit (FCCU) that may employ solids pressurizing feeders;

FIG. 6 is a cross-sectional side view of an embodiment of a rotary disk type pressurizing feeder that may be used in the systems of FIGS. 1-5;

FIG. 7 is a cross-sectional side view of an embodiment of a double-track feeder that may be used in the systems of FIGS. 1-5; and

FIG. 8 is a schematic diagram of an embodiment of a lock hopper that may be used in the systems of FIGS. 1-5.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments provide systems and methods for conveying solids in the presence of fluids. For example, a system may include a first reactor and a second reactor. The first reactor may be configured to receive a first gaseous stream and generate a first solids stream. The second reactor may be configured to receive the first solids stream from the first reactor, receive a second gaseous stream, and generate a second solids stream. A solids pressurizing feeder may be configured to convey the first solids stream or the second solids stream. The solids pressurizing feeder may be configured to at least substantially reduce or prevent unwanted fluid flow between the first reactor and the second reactor while conveying the first solids stream or the second solids stream. For example, the solids pressurizing feeder may substantially reduce or prevent the first gaseous stream from flowing to the second reactor. The solids pressurizing feeder may also substantially reduce or prevent the second gaseous stream from flowing to the first reactor.

An example of the first and second reactors may be a desulfurizer and a regenerator of an IGCC power plant. The fluids used in the desulfurizer and regenerator may be different from one another. By substantially reducing or preventing unwanted fluid flow between the desulfurizer and regenerator, the solids pressurizing feeder may help to prevent operational upsets associated with intermixing of the different fluids between the desulfurizer and regenerator. For example, the different fluids used in the desulfurizer and regenerator may be reactive or flammable with one another. In addition, the solids pressurizing feeder may enable the desulfurizer and regenerator to operate at substantially different pressures, which may improve the efficiency and operational flexibility of the desulfurizer and regenerator. For example, the solids pressurizing feeder may enable the regenerator to operate at a higher pressure than the desulfurizer, which may improve the efficiency of the regenerator. Thus, use of the disclosed solids pressurizing feeders is particularly well suited in aerodynamically coupled fluidized bed systems in which solids circulate between two or more beds, but gases between the beds remain separated.

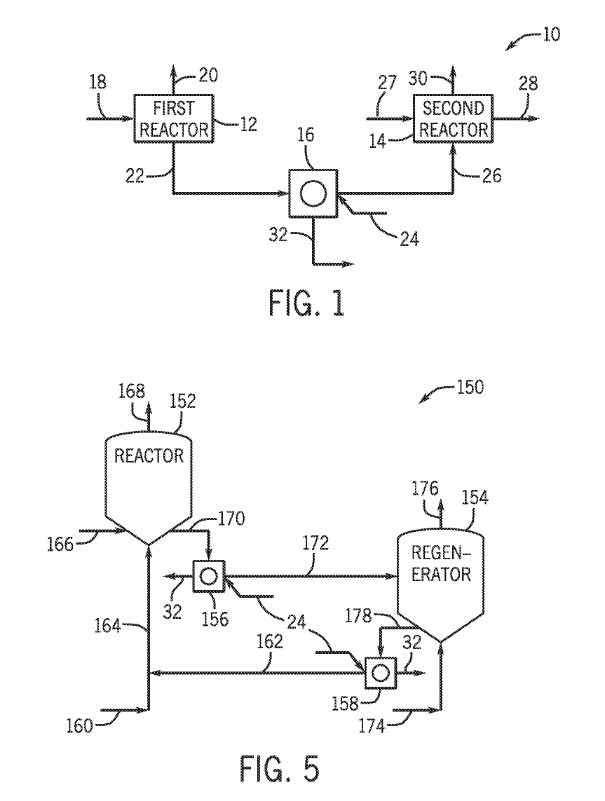

FIG. 1 is a schematic diagram of an embodiment of a system 10 with reactors 12 and 14 that employ a solids pressurizing feeder 16, which may be a device configured to convey solids against a pressure gradient. In other words, the solids pressurizing feeder 16 may convey solids from an area at a first pressure to an area at a second pressure that is higher than the first pressure. In the following discussion, various streams may be referred to by the phase of the primary components of the stream (e.g., a solids stream). However, any of the following streams may also contain other phases (e.g., the solids stream may include liquids and/or gases). The system 10 includes a first reactor 12 and a second reactor 14. One or both of the first and second reactors 12 and 14 may be fluidized bed reactors, or any other type of reactor in which multiphase chemical reactions occur, such as moving bed reactors. Specific examples of such systems are described in detail below. For example, the system 10 may include, but is not limited to, a sulfur removal system, a fluid catalytic cracking unit (FCCU), a pressure swing absorption (PSA) system, a temperature swing absorption (TSA) system, a vacuum swing absorption (VSA) system, and so forth. As shown in FIG. 1, the first reactor 12 receives a first gaseous inlet stream 18 and generates a first gaseous outlet stream 20. A chemical reaction, physical change, adsorption, or absorption may occur in the first reactor 12, generating a first solids stream 22. The first solids stream 22 enters the solids pressurizing feeder 16, which conveys the solids to the second reactor 14 via outlet stream 26. In certain embodiments, an inert buffer gas 24, as described in detail below, may be injected into the outlet stream 26 at the exit of the solids pressurizing feeder 16. The inert buffer gas 24 may help provide a barrier against intermixing of gases between the first and second reactors 12 and 14. For example, a portion of the buffer gas 24 may flow with the outlet stream 26 and assist with the conveyance of the outlet stream 26 to the second reactor 14, while the remainder of the buffer gas 24 enters the solids pressurizing feeder 16. As described in more detail below, the remainder of the buffer gas 24 that enters the solids pressurizing feeder 16 collects in the body of the feeder 16 and forms a vent stream 32 that exits the body of the feeder 16. The vent stream 32 may be recycled for use as the inert buffer gas 24 or may be disposed of in a suitable manner. In certain embodiments, the flow rate of the portion of buffer gas 24 that enters the solids pressurizing feeder 16 is determined by the particle size distribution, the particle packing of the solids being conveyed by the feeder 16, and the pressure gradient across the packed column of solids developed by the solids pressurizing feeder 16. Increases in the flow rate of the buffer gas 24 beyond a certain minimum value tend to increase the portion of the buffer gas 24 that flows with the solids in outlet stream 26. In an alternative embodiment, the flow rate of buffer gas 24 may be increased in order to increase the portion of buffer gas 24 flowing with the solids in outlet stream 26 in order to enhance the conveyance of solids to the second reactor 14. In another alternative embodiment, a second flow of gas (not shown) may be injected into outlet stream 26 immediately downstream of the injection point for buffer gas 24 in order to provide additional conveying gas for the solids in outlet stream 26. This additional conveying gas may be an inert gas, such as nitrogen, or it may be a process gas, such as the gas in the second reactor 26. The solids pressurizing feeder 16 outlet stream 26, which may contain a portion of the buffer gas stream 24 in addition to the first solids stream 22, enters the second reactor 14. In addition, the second reactor 14 may receive a second gaseous inlet stream 27. A chemical reaction, physical change, adsorption, or absorption may occur in the second reactor 14, which may generate a second solids stream 28 and a second gaseous stream 30. The solids pressurizing feeder 16 is configured to substantially reduce or prevent fluid flow (e.g., gas or liquid flow) between the first and second reactors 12 and 14. In further embodiments, the first and second reactors 12 and 14 may include additional inlet and outlet streams, which may include various solids, liquids, and/or gases.

By using the solids pressurizing feeder 16 to reduce or prevent fluid flow between the first and second reactors 12 and 14 in FIG. 1, the operating pressures of the first and second reactors 12 and 14 may be substantially different from one another, rather than operating the first and second reactors 12 and 14 at approximately the same pressures. For example, the operating pressure of the second reactor 14 may be substantially higher than the operating pressure of the first reactor 12. For example, a ratio of a pressure of the second reactor 14 to a pressure of the first reactor 12 may be between approximately 1:1 to 10.0:1, 1.5:1 to 3.0:1, or 2.0:1 to 2.5:1. In other embodiments, the operating pressure of the first reactor 12 may be substantially higher than the operating pressure of the second reactor 14. For example, a ratio of a pressure of the first reactor 12 to a pressure of the second reactor 14 may be between approximately 1:1 to 10.0:1, 1.5:1 to 3.0:1, or 2.0:1 to 2.5:1. In further embodiments, the solids pressurizing feeder 16 also enables the operating pressures of the first and second reactors 12 and 14 to be approximately the same. Furthermore, because the solids pressurizing feeder 16 is capable of reducing or preventing fluid flow between the first and second reactors 12 and 14, the solids pressurizing feeder 16 helps to reduce or prevent intermixing of the gaseous streams of the system 10 that may occur during process transients, such as startups, shutdowns, or process interruptions caused by equipment either upstream or downstream of the system 10. For example, the solids pressurizing feeder 16 may help to reduce or prevent the first gaseous inlet and outlet streams 18 and 20 from flowing into the second reactor 14. The solids pressurizing feeder 16 may also help to reduce or prevent the second gaseous stream 30 and the second gaseous inlet stream 27 from flowing into the first reactor 12. Thus, by using the solids pressurizing feeder 16, any undesirable consequences of intermixing of the gaseous streams in the system 10 may be avoided. Furthermore, the robustness enabled by the solids pressurizing feeder 16 may simplify the design and operation of the system 10, avoiding the need to design and operate the system 10 in such a way that the first and second reactors 12 and 14 are at approximately the same pressure, with gas and solids flow rates governed by pressure drops which may be no greater than a fraction of a kPa. For example, the solids pressurizing feeder 16 may be used to convey solids without having to consider relative densities and/or velocities of solids in different areas of the system 10. The solids pressurizing feeder 16 may also enable the flow rates of solids to be easily adjusted and precisely metered. In further embodiments, the system 10 may include additional reactors and/or additional solids pressurizing feeders. Further, the arrangement of the streams, the reactors, and/or the solids pressurizing feeders may be different in such embodiments.

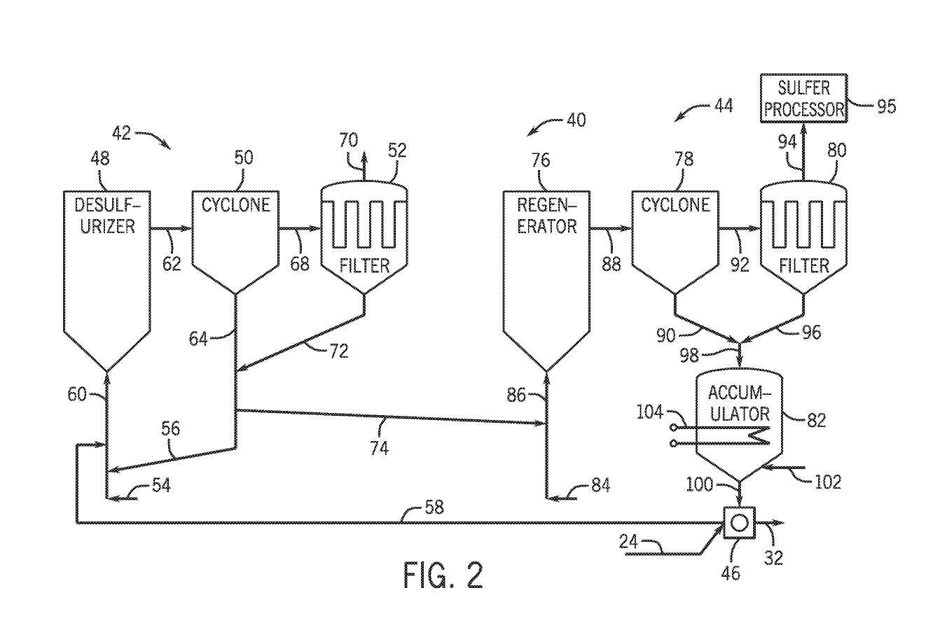

FIG. 2 is a schematic diagram of an embodiment of a sulfur removal system 40 that employs the solids pressurizing feeder 16. The sulfur removal system 40 includes a desulfurization section 42 and a regeneration section 44. The desulfurization and regeneration sections 42 and 44 are interconnected by a regenerated sorbent solids pressurizing feeder 46. Turning to the desulfurization system 42 in more detail, the system 42 includes a desulfurizer 48, a cyclone 50, and a filter 52. Together, the cyclone 50 and the filter 52 may be referred to as a separation system. The desulfurizer 48 is a fluidized bed reactor that uses a solid sorbent to absorb sulfur compounds, such as hydrogen sulfide and carbonyl sulfide, from a raw synthesis gas stream 54, which may be generated by a gasifier of the IGCC power plant. Synthesis gas may also be referred to as syngas. The raw syngas stream 54 may include a variety of gases, including, but not limited to, carbon monoxide, hydrogen, carbon dioxide, steam, methane, nitrogen, argon, ammonia, carbonyl sulfide, hydrogen sulfide, and combinations thereof. In some embodiments, the raw syngas stream 54 may also include unreacted fuel from the gasifier. In certain embodiments, the raw syngas 54 may optionally pass through a scrubber to remove particulates and/or a carbonyl sulfide hydrolysis unit to convert carbonyl sulfide into hydrogen sulfide before being sent to the desulfurizer 48. In further embodiments, the raw syngas 54 may be any other gaseous stream that includes sulfur compounds, such as, but not limited to, hydrogen sulfide and carbonyl sulfide.

As shown in FIG. 2, the raw syngas stream 54 combines with at least partially sulfided sorbent 56 recycled from the cyclone 50 and the filter 52. Partially sulfided sorbent refers to sorbent that has absorbed some sulfur compounds, such as hydrogen sulfide and carbonyl sulfide, but that has not absorbed enough sulfur compounds to become fully saturated. As used herein, the term sulfided sorbent includes sorbent that has been at least partially sulfided and that may, in fact, consist primarily of sorbent material that has only been partly sulfided as opposed to fully sulfided. Thus, the sulfided sorbent 56 still has the potential to absorb more sulfur compounds. The raw syngas 54 and the sulfided sorbent 56 then combine with an at least partially regenerated sorbent 58 from the regeneration system 44. As used herein, the term regenerated sorbent is understood to refer to sulfided sorbent that has at least been partially regenerated and that may, in fact, consist primarily of sorbent material that has only been partly regenerated as opposed to fully regenerated. Thus, the term regenerated sorbent includes sorbent that has had at least some, and perhaps most, or even all, of its absorbed sulfur removed by regeneration. In some embodiments, the order in which the partially sulfided sorbent stream 56, the partially regenerated sorbent stream 58, and the raw syngas stream 54 mix may be different. A mixture 60 of the raw syngas 54, sulfided sorbent 56, and regenerated sorbent 58 then enters the desulfurizer 48. In the desulfurizer 48, the sorbent absorbs hydrogen sulfide and carbonyl sulfide in the mixture 60 via the following reactions:

H₂S+MO=>MS+H₂O (EQUATION 1)

COS+MO=>MS+CO2 (EQUATION 2)

in which MO represents the metal oxide form of the sorbent material, MS represents the metal sulfide form of the sorbent material, H₂S represents hydrogen sulfide, H₂O represents water, COS represents carbonyl sulfide, and CO₂ represents carbon dioxide. Specifically, the sorbent material MO may be a metal oxide in which the metal may be selected from zinc, magnesium, calcium, sodium, manganese, iron, copper, nickel, cobalt, cerium, and similar metals. An outlet stream 62 from the desulfurizer 48 may include syngas, steam, carbon dioxide, unsulfided sorbent, and sulfided sorbent having varying degrees of sulfidation.

The outlet stream 62 from the desulfurizer 48 then enters the cyclone 50, which separates solids from gases. Specifically, the cyclone 50 may remove solids from gases through vortex separation. In other words, rotational effects and gravity are used to separate mixtures of solids and gases in the cyclone 50. In further embodiments, other methods of separating solids from gases may be used instead of the cyclone 50. Exiting the bottom of the cyclone 50 is a sulfided sorbent 64, and exiting the top or side of the cyclone 50 is a cyclone gaseous stream 68, which is then sent to the filter 52. The cyclone outlet stream 68 may contain some solid material and thus, the filter 52 is used to remove the remaining sorbent from the gaseous stream using filtration. In other embodiments, the filter 52 may be another cyclone or any other type of solid-gas separation device. Exiting the top of the filter 52 is a desulfurized syngas 70 that is substantially free of sulfur compounds. In certain embodiments, substantially free of sulfur compounds may correspond with a sulfur level of less than 50 parts per million by volume (ppmv), 10 ppmv, 5 ppmv, or 1 ppmv. The desulfurized syngas 70 may be used in a variety of applications. For example, the desulfurized syngas 70 may be introduced into a gas turbine to generate power in the IGCC power plant. Leaving the bottom of the filter 52 is a sulfided sorbent 72. The sulfided sorbent 64 from the cyclone 50 and the sulfided sorbent 72 from the filter 52 may combine to form the sulfided sorbent 56 that is returned to the desulfurizer 48. Since not all of the sorbent in the sulfided sorbent 56 is completely sulfided, the sulfided sorbent 56 may continue to be used to desulfurize additional raw syngas 54. However, a portion of the sulfided sorbent 64 and 72 may be transferred through a transfer line 74 to the regeneration system 44.

The regeneration system 44 shown in FIG. 2 includes a regenerator 76, a cyclone 78, and a filter 80. As with the desulfurization section 42, the cyclone 78 and the filter 80 may be referred to together as a separation system. In addition, the regeneration system 44 may include a regenerated sorbent accumulator 82 that may be used with the regenerated sorbent solids pressurizing feeder 46 described in detail below. The regenerator 76 is a fluidized bed reactor that uses a regeneration gas to regenerate the sulfided sorbent 74, i.e., remove sulfur from the sulfided sorbent 74. Specifically, the regenerator 76 may be fed a regeneration gas 84, or oxygen-containing gas, that includes, but is not limited to, oxygen, nitrogen, air, steam, or a combination thereof. The regeneration gas 84 combines with the sulfided sorbent 74 to form a regenerator inlet stream 86. In the regenerator 76, the sulfided sorbent is regenerated via the following reaction:

MS+3/2O₂=>MO+SO₂ (EQUATION 3)

in which MS represents the metal sulfide form of the sorbent material, O₂ represents oxygen, MO represents the metal oxide form of the sorbent material, and SO₂ represents sulfur dioxide. Thus, sulfur has been removed from the sorbent material, transforming at least some of it from the metal sulfide form to the metal oxide form to produce partially regenerated sorbent material that may be recycled to the desulfurization section 42 to absorb more sulfur compounds. The regenerator outlet stream 88, which includes the regenerated sorbent and sulfur dioxide, is then fed to the cyclone 78.

In the cyclone 78, the regenerated sorbent is separated from the sulfur dioxide through vortex separation. As with the desulfurization system 42, in other embodiments, the cyclone 78 may utilize other methods of gas-solid separation. Regenerated sorbent 90 exits the bottom of the cyclone 78 and a cyclone outlet stream 92 exits the top or side of the cyclone 78. The filter 80 is used to remove any remaining solids from the cyclone outlet stream 92 using filtration. As with the desulfurization system 42, in other embodiments, the filter 80 may use cyclonic separation or any other method of gas-solid separation. Exiting the top of the filter 80 is a regeneration off-gas 94 that may include sulfur dioxide and steam, as well as excess oxygen, nitrogen, or vitiated air. In certain embodiments, the regeneration off-gas 94 may be sent to a sulfur processor 95 that may produce elemental sulfur from the sulfur dioxide. For example, a Direct Sulfur Recovery Process may use a catalyst to react the hydrogen and carbon monoxide in a small slipstream of syngas with the sulfur dioxide to produce elemental sulfur, carbon dioxide, and water. In other embodiments, the sulfur processor 95 may produce other chemicals, such as sulfuric acid, from the sulfur dioxide in the regeneration off-gas 94.

Exiting the bottom of the filter 80 is a regenerated sorbent 96. The regenerated sorbent 90 from the cyclone 78 and the regenerated sorbent 96 from the filter 80 combine to form a regenerated sorbent inlet 98, which enters the regenerated sorbent accumulator 82. The accumulator 82 may be a vessel used to provide hold up capacity for the regenerated sorbent 98 being fed to the regenerated sorbent solids pressurizing feeder 46. In other words, the accumulator 82 stores the regenerated sorbent 98 to enable a continuous regenerated sorbent stream 100 to be fed to the regenerated sorbent solids pressurizing feeder 46 despite fluctuations of the regenerated sorbent stream 98. In certain embodiments, the accumulator 82 may include a purge gas 102 introduced near the bottom of the accumulator 82 to fluidize the regenerated sorbent 98 to help with stripping of any remaining regeneration off-gas 94. For example, the purge gas 102 may be an inert gas, such as nitrogen or carbon dioxide. In certain other embodiments, the accumulator 82 may include internal cooling coils 104 for removing heat from the sorbent regeneration process, which typically occurs at temperatures several hundred degrees Celsius higher than the temperatures at which the desulfurization occurs. The cooling coils 104 may use steam, condensate, boiler feed water, nitrogen, heat transfer fluids, or some other process fluid as the cooling medium. In still other embodiments, the accumulator 82 may not include the cooling coils 104 in order to allow the solids pressurizing feeder 46 to return hot, uncooled sorbent particles to the inlet of the desulfurizer 48. Returning hot sorbent particles may allow the inlet raw syngas 54 to enter the desulfurizer 48 at a lower temperature than it would if the solids pressurizing feeder 46 returned cooler particles while still achieving a high enough temperature in the desulfurizer 48 for the desulfurization reactions to occur at a practical rate. The regenerated sorbent solids pressurizing feeder 46 may include the inert buffer gas 24 at the exit of the feeder and the vent gas 32 from the body of the feeder, as described in detail below. The regenerated sorbent solids pressurizing feeder 46 then conveys the regenerated sorbent 58 to the desulfurization system 42.

Use of the regenerated sorbent solids pressurizing feeder 46 may help to reduce or prevent the regeneration gas 84 from entering the desulfurization system 42, which may cause an undesirable reaction between the oxygen contained in the regeneration gas 84 and the syngas in the raw syngas 54. Similarly, the regenerated sorbent solids pressurizing feeder 46 may help to reduce or prevent the raw syngas 54 from entering the lower portion of the regeneration system 44, which may also cause undesirable chemical reactions and reheating of the regenerated sorbent, which was cooled by cooling coils 104. Otherwise, without using the regenerated sorbent solids pressurizing feeder 46, the separation of desulfurization and regeneration gases in the regenerated sorbent return line 58 would use complicated, multi-component systems and large flow rates of inert gas to help prevent intermixing of gases and to convey the regenerated sorbent particles back to the desulfurizer 48. Instead, the regenerated sorbent solids pressurizing feeder 46 may provide the advantages discussed above in a single, simple piece of equipment.

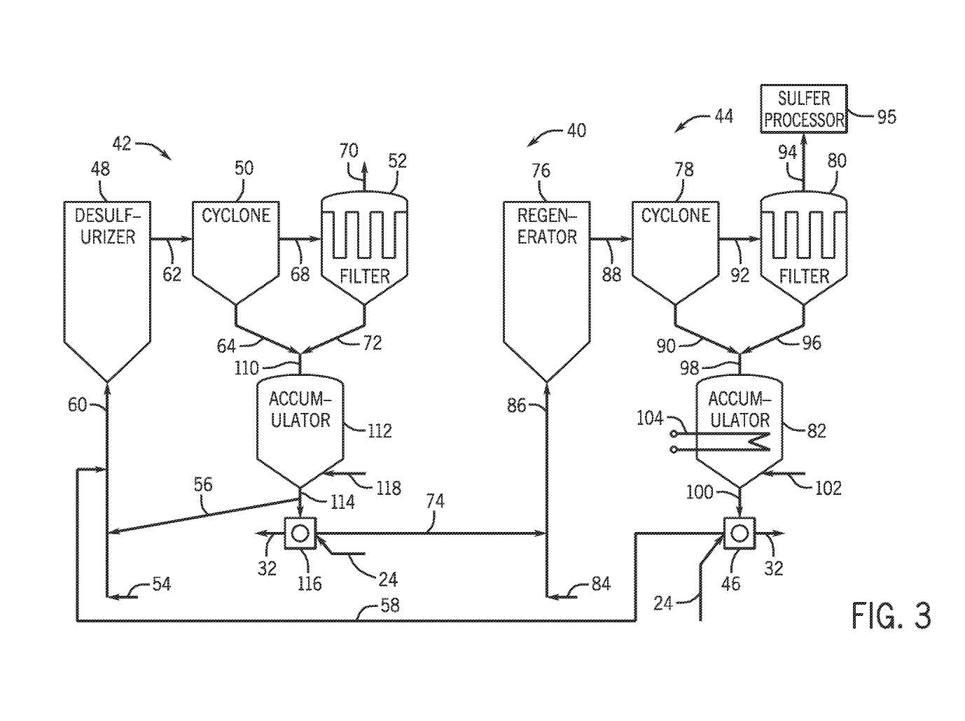

FIG. 3 is a schematic diagram of an embodiment of the sulfur removal system 40 that uses two solids pressurizing feeders 16. Specifically, the regeneration 44 includes the regenerated sorbent solids pressurizing feeder 46 described in detail above, and also a sulfided sorbent solids pressurizing feeder 116 in the desulfurization system 42. In the desulfurization system 42, the sulfided sorbent 64 from the cyclone 50 and the sulfided sorbent 72 from the filter 52 combine to form a sulfided sorbent inlet stream 110 to a sulfided sorbent accumulator 112. A portion of the sulfided sorbent in the sulfided sorbent accumulator 112 returns to the desulfurizer 48 as the sulfided stream 56. In certain embodiments, the sulfided sorbent accumulator 112 may include a purge gas 118 introduced near the bottom to fluidize the sulfided sorbent 110 to help with stripping of any remaining desulfurized syngas 70. For example, the purge gas 118 may be an inert gas, such as nitrogen or carbon dioxide. A sulfided sorbent outlet stream 114 leaves the sulfided sorbent accumulator 112 to feed the sulfided sorbent solids pressurizing feeder 116. As with the regenerated sorbent solids pressurizing feeder 46, the sulfided sorbent solids pressurizing feeder 116 may include the inert buffer gas 24 at the exit of the feeder and the vent gas 32 from the body of the feeder to help reduce or prevent the unwanted intermixing of gases. The sulfided sorbent solids pressurizing feeder 116 conveys the sulfided sorbent through the transfer line 74 to the regeneration system 44. The use of the sulfided sorbent solids pressurizing feeder 116 may help to reduce or prevent the regeneration gas 84 from flowing backward through the transfer line 74 and into the desulfurization system 42. In addition, the sulfided sorbent solids pressurizing feeder 116 enables the regeneration and desulfurization systems 44 and 42 to be operated at substantially different pressures. For example, a ratio of a pressure of the regeneration system 44 to a pressure of the desulfurization system 42 may be between approximately 1:1 to 10.0:1, 1.5:1 to 3.0:1, or 2.0:1 to 2.5:1. Operating the desulfurization and regeneration systems 42 and 44 at different pressures may improve the efficiency and/or operating flexibility of the reactions in the desulfurization and regeneration systems 42 and 44. Otherwise, without using the regenerated sorbent solids pressurizing feeder 46, the desulfurization and regeneration systems 42 and 44 may be operated at approximately the same pressure. In certain embodiments, the sulfur removal system 40 may include the sulfided sorbent solids pressurizing feeder 116 and omit the regenerated sorbent solids pressurizing feeder 46. In other respects, the sulfur removal system 40 is similar to that described with respect to FIG. 2.

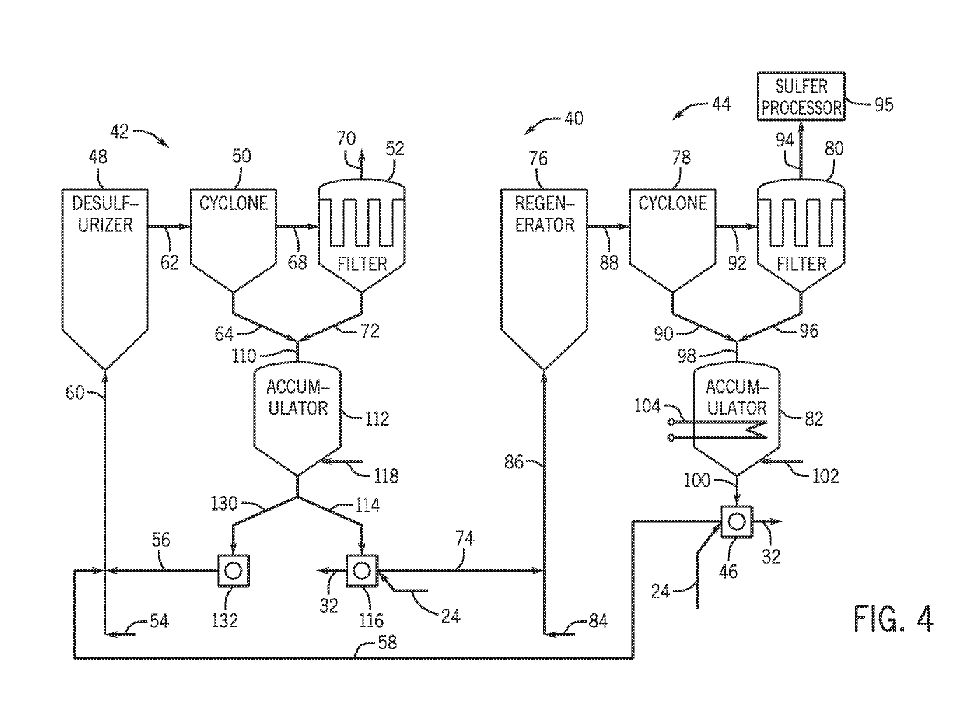

FIG. 4 is schematic diagram of an embodiment of the sulfur removal system 40 that uses three solids pressurizing feeders 16. Specifically, the sulfur removal system 40 includes the regenerated sorbent solids pressurizing feeder 46 and the sulfided sorbent solids pressurizing feeder 116. In addition, sulfided sorbent 130 from the sulfided sorbent accumulator 112 is fed to a recycled sorbent solids pressurizing feeder 132. Unlike the previous solids pressurizing feeders, the recycled sorbent solids pressurizing feeder 132 does not require an inert buffer gas stream to help prevent intermixing of gases because the gases on either side of the feeder are the same. The recycled sorbent solids pressurizing feeder 132 conveys the sulfided sorbent 56 to the desulfurizer 48. In other words, the recycled sorbent solids pressurizing feeder 132 may circulate the sulfided sorbent 56 in the desulfurizer 48. In fact, it may be used to precisely meter the flow rate of sulfided sorbent 56 into the raw syngas 54, even as the regenerated solids pressurizing feeder 46 may be used to precisely meter the flow rate of regenerated sorbent 58 into the raw syngas 54. Use of the recycled sorbent solids pressurizing feeder 132 may improve operability of the sulfur removal system 40 during process upsets. For example, during a process upset, startup, or shutdown, the pressure or flow rate of the raw syngas 54 may increase. If the recycled sorbent solids pressurizing feeder 132 is not used, such upsets may possibly interfere with the flow of the sulfided sorbent 56 into the desulfurizer 48. However, the recycled sorbent solids pressurizing feeder 132 may provide a steady flow rate of the sulfided sorbent 56 to the desulfurizer 48 despite fluctuations of the pressure of the raw syngas 54. In addition, use of the recycled sorbent solids pressurizing feeder 132 may help reduce or prevent raw syngas 54 from entering the sulfided sorbent accumulator 112 and/or enable pressures of the desulfurizer 48 and the sulfided sorbent accumulator 112 to be different from one another. In certain embodiments, the sulfur removal system 40 may include the recycled sorbent solids pressurizing feeder 132 and omit the regenerated sorbent solids pressurizing feeder 46 and the sulfided sorbent solids pressurizing feeder 116. In other embodiments, the sulfur removal system 40 may include the recycled sorbent solids pressurizing feeder 132 and either the regenerated sorbent solids pressurizing feeder 46 or the sulfided sorbent solids pressurizing feeder 116.

FIG. 5 is a schematic diagram of an embodiment of a fluid catalytic cracking unit (FCCU) 150 that employs solids pressurizing feeders 16. Fluid catalytic cracking is a process used in petroleum refineries to convert high boiling, high molecular weight hydrocarbon fractions of petroleum crude oils to more valuable gasoline, olefinic gases, and other products. FIG. 5 shows a simplified version of a portion of the FCCU 150 that includes a reactor 152, a regenerator 154, a spent catalyst solids pressuring feeder 156, and a regenerated catalyst solids pressurizing feeder 158. The feed to the reactor 152 is a raw oil 160 that may contain high boiling, high molecular weight hydrocarbon fractions. The raw oil 160 combines with regenerated catalyst 162 from the regenerated catalyst solids pressurizing feeder 158 to form a reactor feed 164. Inside the reactor 152, a catalyst in the fluidized bed portion of the reactor 152 cracks the raw oil 160 into more valuable fractions. Steam 166 is fed to an internal stripper portion of the reactor 152 to separate any hydrocarbons from the spent catalyst. In addition, the reactor 152 may include one or more cyclones to separate the catalyst from the gases. Accordingly, a reaction product gas 168, which includes the more valuable fractions, exits from the top of the reactor 152 and may be sent to one or more distillation columns for further processing. Spent catalyst 170 is sent to the spent catalyst solids pressurizing feeder 156 to be conveyed through a transfer line 172 to the regenerator 154. As with previously discussed solids pressurizing feeders, the spent catalyst solids pressurizing feeder 156 may include the inert buffer gas 24 to help reduce or prevent unwanted intermixing of gases. Also, as previously discussed, the spent catalyst solids pressurizing feeder 156 may include an upstream solids accumulator vessel (not shown) to help ensure an adequate and steady supply of solids to the suction of the feeder 156. Combustion air 174 is fed to the regenerator 154 to burn off deposits of coke that have developed on the spent catalyst, thereby producing regenerated catalyst. The regenerator 154 may include one or more cyclones to separate the regenerated catalyst from the gases. A flue gas 176, which may include carbon monoxide and carbon dioxide, exits from the top of the regenerator 154 and regenerated catalyst 178 exits from the bottom of the regenerator 154 to be fed to the regenerated catalyst solids pressurizing feeder 158. Again, the feeder 158 may include the inert buffer gas 24 to help reduce or prevent unwanted intermixing of gases. In addition, as previously discussed, the regenerated catalyst solids pressurizing feeder 158 may include an upstream solids accumulator vessel (not shown) to help ensure an adequate and steady supply of solids to the suction of the feeder 158. The spent catalyst and regenerated catalyst solids pressurizing feeders 156 and 158 may enable the reactor 152 and the regenerator 154 to operate at substantially different pressures and may help reduce or prevent intermixing of the gases and vapors in the reactor 152 and regenerator 154. Operating the reactor 152 and the regenerator 154 at different pressures using feeders 156 and 158 may improve efficiency and/or operating flexibility without adding additional components and/or complexity to the fluid catalytic cracking unit 150. In certain embodiments, only one of the spent catalyst or regenerated catalyst solids pressurizing feeders 156 and 158 may be a solids pressurizing feeder 16.

As mentioned above, the multi-reactor systems 10, 40, and 150 may include one or more solids pressurizing feeders 16. In certain embodiments, the solids pressurizing feeder 16 may be a rotary disk type pressurizing feeder, such as a Posimetric® Feeder by General Electric Company of Schenectady, N.Y. A rotary disk type pressurizing feeder of the type manufactured by General Electric provides both pressurization and precise metering of solids, such as particulate fuels or other matter. For example, the rotary disk type pressurizing feeder may induce the solids entering a converging inlet channel of the feeder to compact to the point where they achieve what is referred to as “lockup,” a condition in which the solid particles are interlocked in such a way that they become bridged within the rotating part (the rotor) of the feeder, which drives the solids from the inlet to the outlet at a steady, metered rate. In a diverging outlet channel of the feeder, the solids may be subjected upstream to the force of the constantly advancing solids that are locked up and being driven forward by the rotor and downstream to the high pressure environment into which the solids are being transported. Under these compressive forces from both upstream and downstream, the solids in the outlet channel may compact even further and may form a dynamic, packed bed that is highly resistant to the backflow of fluids (gases or liquids) from the high-pressure environment at the discharge of the feeder. It is this zone of highly packed, flow resistant particulate solids that may help prevent significant backflow of fluids from the high-pressure outlet to the low-pressure inlet of the pump. The highly packed, flow resistant zone may be an imperfect seal, and some fluid may leak backwards through the packed solids. However, the amount of backflow may be small, and the small amount of fluid that may work its way through the tightly packed solids in the outlet channel may be collected in a vent and, thus, may be prevented from flowing backwards all the way to the feeder inlet. Thus, by preventing backflow of gas, the rotary disk type solids pressurizing feeder may help prevent unwanted intermixing of various gas streams in the process in which the rotary disk type solids pressurizing feeder is used. Further, the zone of highly compacted solids at the outlet of the feeder enables the pressures at the inlet and outlet of the rotary disk type solids pressurizing feeder to be substantially different from one another. For example, the pressure at the outlet of the feeder may be substantially greater than the pressure at the inlet of the feeder. Thus, the systems interconnected by the rotary disk type solids pressurizing feeder may be able to operate at substantially different pressures.

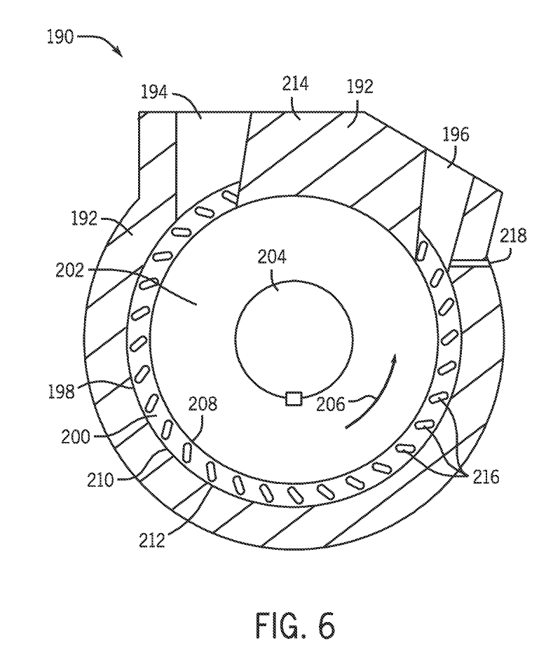

FIG. 6 is a cross-sectional side view of an embodiment of a rotary disk type solids pressurizing feeder 190 that may be used in the systems of FIGS. 1-5, illustrating operational features of the rotary disk type solids pressurizing feeder 190. The rotary disk type solids pressurizing feeder 190 may be a Posimetric® Feeder made by General Electric Company of Schenectady, N.Y. As shown in FIG. 6, the rotary disk type solids pressurizing feeder 190 includes a pressure housing (or body) 192, an inlet channel 194, an outlet channel 196, and a rotor 198. The rotor 198 may include two substantially opposed and parallel rotary disks 200 separated by a hub 202 and joined to a shaft 204 that is common to the parallel disks 200 and the hub 202. Note that, in FIG. 6, the two disks 200 are not in the plane of the page, as are the rest of the elements in the figure. One of the disks 200 is below the plane of the page, and the other disk 200 is above the plane. The disk 200 below the plane of the page is projected onto the plane of the page in order that it may be seen in relation to the rest of the components comprising the disk type solids pressurizing feeder 190. The outer, convex surface 208 of the hub 202, the annularly shaped portion of the two disks 200 that extend between the outer surface of the hub 202 and the peripheral edge 210 of the disks 200, and the inner, concave surface 212 of the feeder housing 192 define an annularly shaped, rotating channel that connects the converging inlet channel 194 and the diverging outlet channel 196. A portion 214 of the feeder body 192 that is disposed between the inlet channel 194 and the outlet channel 196 divides the rotating channel in such a way that solids entering the inlet channel 194 may travel only in the direction of rotation 206 of the rotor, so that the solids may be carried from the inlet channel 194 to the outlet channel 196 by means of the rotating annularly shaped channel defined by the rotating outer surface of the hub 202, the rotating exposed annular surfaces of the disks 200 and the stationary inner surface 212 of the body 192.

As solids enter and move downwards through the converging inlet channel 194, the particles progressively compact. As the particles continue to be drawn downwards and into the rotating channel, the compaction may reach a point where the particles become interlocked and form a bridge across the entire cross-section of the channel. As the compacted particles continue to move through the rotating channel in the direction of rotation 206, the length of the zone containing particles which have formed an interlocking bridge across the entire cross-section of the rotating channel may become long enough that the force required to dislodge the bridged particulates from the channel exceeds the force that can be generated by the high pressure environment at the outlet of the feeder 190. This condition, where the interlocking solids within the rotating channel cannot be dislodged by the high pressure at the outlet of the feeder 190, is referred to as “lockup.” By achieving the condition of lockup, the torque delivered by the shaft 204 from the drive motor (not shown) may be transferred to the rotating solids so that the solids are driven from the inlet channel 194 to the outlet channel 196 against whatever pressure exists in the high-pressure environment beyond the exit of the outlet channel 196. In some embodiments, the rotor disks 200 may have raised or depressed surface features 216 formed onto their surfaces. These features may enhance the ability of the particulate solids to achieve lockup in the rotating channel and, therefore, may also enhance the ability of the drive shaft 204 to transfer torque to the rotating solids. In another embodiment, a live wall hopper (not shown in any of the previous figures) may be attached immediately upstream of the inlet channel 194 of the feeder 190. The live wall hopper may enhance the ability of the particulate solids to flow into and completely fill the inlet channel 194. So, for example, in FIG. 2, a live wall hopper may be inserted between accumulator 82 and solids pressurizing feeder 46. As the particles in the rotating channel reach the outlet channel 196, they encounter the diverging walls of the outlet channel 196.

As the particles move through the diverging outlet channel 196, the forces that held them in the lockup condition begin to relax to the point where, at the downstream exit of the outlet channel 196, the particles are able to freely disengage from the outlet channel 196 and proceed downstream. However, at the upstream inlet to the diverging outlet channel 196, the solids may be subjected upstream to the force of the constantly advancing solids that are locked up and being driven forward by the rotor and downstream to the high-pressure environment into which the solids are being transported. Under these compressive forces from both upstream and downstream, the solids in the upstream inlet to the outlet channel 196 may compact even further and may form a dynamic, packed bed that is highly resistant to the backflow of fluids (gases or liquids) from the high-pressure environment at the discharge of the feeder 190. It is this zone of highly packed, flow resistant particulate solids that may prevent significant backflow of fluids from the high-pressure outlet to the low-pressure inlet of the pump 190. Of course, this highly packed, flow resistant zone may be an imperfect seal, and some fluid may leak backwards through the tightly packed solids at the upstream inlet of the outlet channel 196. However, the amount of backflow may be small, and the small amount of fluid that may work its way through the tightly packed solids may be collected in a vent 218 and, thus, may be prevented from flowing backwards all the way to the feeder inlet. The small amount of fluid (gases or liquids) that may be collected in the vent may either be disposed of or, preferably, recycled to an appropriate location elsewhere in the process. As a result of the dynamic packed bed at the inlet of the outlet channel 196 that is highly resistive to fluid backflow, and by collecting the small amount of fluid which may work its way back through the dynamic packed bed, the rotary disk type solids pressurizing feeder 190 may function as a means to separate two reactors having widely differing pressures and significantly differing chemical compositions.

The operation of the rotary disk type solids pressurizing feeder 190 shown in FIG. 6 was explained above for an embodiment in which the rotation of the annularly shaped channel was from the inlet channel 194, which is at lower pressure, to the outlet channel 196, which is at higher pressure. Such an application may be called “pressurizing mode.” However, the rotation of the disks, and hence of the annularly shaped channel, may be reversed so that the direction of rotation runs from the higher-pressure outlet channel 196 to the lower pressure inlet channel 194. When this is done, along with some appropriate modifications to the geometries of the inlet and outlet channels, the rotating disk type solids pressurizing feeder 190 works as a solids depressurizing feeder. Such an embodiment may be called “depressurizing mode.” When operating in depressurizing mode, the solid particulates from a high-pressure zone enter what was called the outlet channel 196 in FIG. 6. As they progress downwards through the outlet channel, they move through the dynamic, highly compacted zone at the bottom of the outlet channel 196 that forms the highly back flow resistant zone that prevents unwanted backflow from the high-pressure region at the outlet channel 196 to the low-pressure region at the inlet channel 194. As the annularly shaped channel continues to rotate in the opposite direction from what is shown in FIG. 6, the solids are carried back to the inlet channel 194 where the locking forces that held them in place inside the rotating channel relax and allow the solids to disengage from one another as they exit the inlet channel 194 on the low pressure side of the feeder 190. Note that, for every application in which a lower pressure reactor vessels is coupled together with a higher pressure reactor vessel, at least one solids pressurizing feeder 16 operating in pressurizing mode and one solids pressurizing feeder 16 operating in depressurizing mode must be used. For the case where two vessels operating at essentially the same pressure are coupled using two solids pressurizing feeders 16, the feeders may both operated in the pressurizing mode. However, in such an application, the differential pressure developed by each of the feeders is only that which is required to overcome the pressure losses in the conduits connecting the vessels in the system.

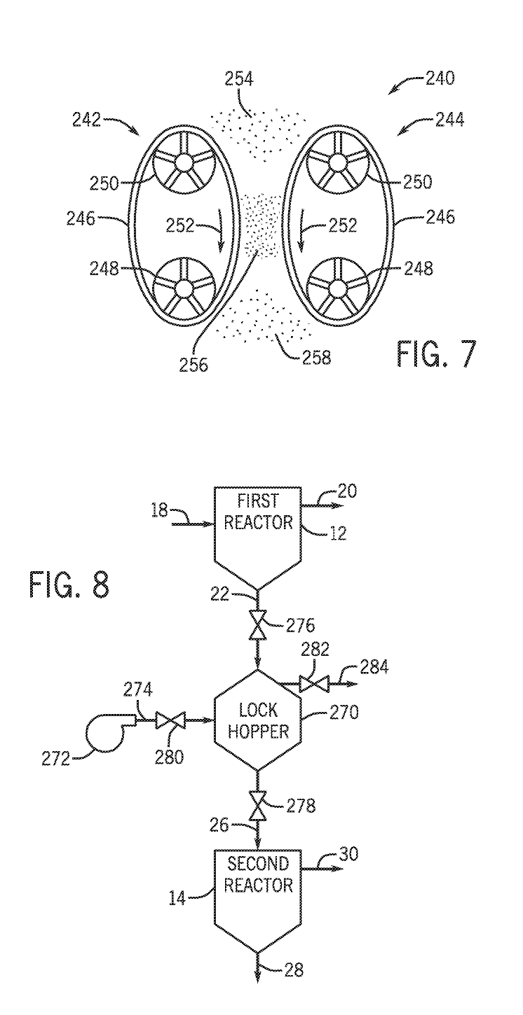

FIG. 7 is a cross sectional side view of an embodiment of a double-track feeder 240, which may also be used as the solids pressurizing feeder 16 in any of the systems of FIGS. 1-5. As shown in FIG. 7, the double-track feeder 240 includes a first conveyor system 242 and second conveyor system 244. Both the first and second conveyor systems 242 and 244 include a conveyor belt 246 disposed about a first wheel 248 and a second wheel 250. Rotation of the first and second wheels 248 and 250 may cause rotation of the conveyor belt 246 in the direction of the arrow 252. The two conveyor belts 246 are constructed with mechanical features (not shown because they are out of the plane of the figure) which allow the two belts to interlock in such a manner that they form an entirely enclosed solids transporting channel between them that continuously interlocks as the two belts approach each other at the entrance of the feeder 254 and continuously unlocks as the two belts retreat from each other at the exit of the feeder 258. Not shown in FIG. 7 are the details of the feeder body and the means by which the moving conveyor belts are sealed within the body so that gases cannot move from the exit to the inlet of the feeder along the sides of the conveyor belts 246 that face away from the solids being conveyed. Solids to be conveyed by the double-track feeder 240 enter at an entrance 254 and are moved by the motion 252 of the conveyor belts 246. As shown in FIG. 7, the passage through which the solids are conveyed narrows near a throat 256 of the double-track feeder 240. Thus, the solids are compacted in the throat 256 of the double-track feeder 240. Such compaction of the solids in the throat 256 may correspond to the solids lockup condition and/or the dynamic, back flow resistant, highly compacted solids region created at the upstream end of the outlet channel 196 by the disk type solids pressurizing feeder 190. The solids emerge at an exit 258 of the double-track feeder 240. As with the design of the solids pressurizing feeder 190, the double-track feeder 240 helps to reduce or prevent unwanted backflow of any gases through the double-track feeder 240, because of the solids lockup condition and/or the back flow resistant, highly compacted solids region at the throat 256. In addition, the double-track feeder 240 may include the inert buffer gas 24 to provide an additional barrier to intermixing of gases. Further, the operating pressures at the exit 258 and the entrance 254 may be substantially different from one another. Thus, the double-track feeder 240 may be particularly well suited to be used as the solids pressurizing feeders 16 in the systems of FIGS. 1-5.

FIG. 8 is a cross sectional side view of an embodiment of a lock hopper 270, which may also be used as the solids pressurizing feeder 16 in the systems of FIGS. 1-5. As shown in FIG. 8, the lock hopper 270 is disposed between the first reactor 12 and the second reactor 14. A compressor 272 is coupled to the lock hopper 270 to provide a source of compressed gas 274, which may also be used as the inert buffer gas 24, in addition to providing the source of pressure for the system. Depending upon the particular process in which the lock hopper 270 is used, the compressed gas 274 may include, but is not limited to, air, argon, nitrogen, or any gas that is compatible with the process in which it is being used. During operation of the lock hopper 270, all valves in the system start in the closed position. Then, a first lock hopper valve 276 is opened to allow the first solids stream 22 to enter the lock hopper 270. The first lock hopper valve 276 is closed once the lock hopper 270 reaches a certain level or amount of the first solids stream 22. Then, first block valve 280 is opened and blower 272 is operated to increase the pressure of the lock hopper 270 using the compressed gas 274. In addition, the second block valve 282 may also be opened temporarily to allow the compressed gas 274 to be used to purge any gas from the first reactor 12 from the lock hopper 270 via a vent line 284. Once the pressure inside the lock hopper 270 has reached a suitable value, the first block valve 280 is closed, the compressor 274 is stopped, and the second lock hopper valve 278 is opened to enable the pressurized, second solids stream 26 to exit from the lock hopper 270 into the second reactor 14. In certain embodiments, the compressor 272 may remain on during this process. After the lock hopper 270 is emptied, the second lock hopper valve 278 is closed and the pressure inside the lock hopper 270 is vented via the second block valve 282 and the vent line 284 until the pressure inside the lock hopper once again equals the pressure of the first reactor 12. During this venting process, any gas from the second reactor 14 that may have flowed backwards into lock hopper 270 during the transfer of the second solids stream 26 from the lock hopper 270 to the second reactor 14 may be purged from the lock hopper 270 using the compressor 272 and the vent line 284. At this point, the first lock hopper valve 276 may be opened and the process repeated. Thus, the lock hopper 270 may be used to convey solids when the operating pressure of the second reactor 14 is greater than the operating pressure of the first reactor 12. In other words, a lock hopper system that includes the lock hopper 270, compressor 272, first lock hopper valve 276, second lock hopper valve 278, and first and second block valves 280 and 282 isolates the first reactor 12 from the second reactor 14 during the conveying process. This isolation enables the pressures of the first and second reactors 12 and 14 to be substantially different from one another. In addition, by venting any gases from the second reactor 14 prior to filling the lock hopper 270 from the first reactor 12, any intermixing of gases from the first and second reactors 12 and 14 may be avoided. Thus, the lock hopper system is another example of a solids pressurizing feeder 16 that may be used in the previously discussed embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a desulfurizer configured to receive a gaseous stream, wherein the desulfurizer comprises a sulfur absorption material configured to absorb a sulfur compound from the gaseous stream to generate a saturated sulfur absorption material and a product stream substantially free of the sulfur compound;
a regenerator configured to receive the saturated sulfur absorption material from the desulfurizer, wherein the regenerator is configured to regenerate the saturated sulfur absorption material to generate a regenerated sulfur absorption material and sulfur dioxide; and
a solids pressurizing feeder configured to continuously convey the sulfur absorption material, the saturated sulfur absorption material, or the regenerated sulfur absorption material, wherein the solids pressurizing feeder is configured to at least substantially reduce or prevent fluid flow between the desulfurizer and the regenerator.

2. The system of claim 1, wherein the sulfur compound comprises at least one of hydrogen sulfide, or carbonyl sulfide, or a combination thereof.

3. The system of claim 1, comprising:
a first solids pressurizing feeder configured to continuously convey the saturated sulfur absorption material from the desulfurizer to the regenerator; and
a second solids pressurizing feeder configured to continuously convey the regenerated sulfur absorption material from the regenerator to the desulfurizer, wherein the desulfurizer operates at a first pressure, the regenerator operates at a second pressure, and the first and second solids pressurizing feeders at least substantially reduce or prevent fluid flow between the desulfurizer and the regenerator such that the first and second pressures are different from one another.

4. The system of claim 1, wherein the solids pressurizing feeder is configured to continuously convey the regenerated sulfur absorption material from the regenerator to the desulfurizer.

5. The system of claim 1, wherein the solids pressurizing feeder is configured to continuously convey the saturated sulfur absorption material from the desulfurizer to the regenerator.

6. The system of claim 1, wherein the solids pressurizing feeder is configured to continuously circulate the sulfur absorption material in the desulfurizer.

7. The system of claim 1, wherein the regenerator is configured to receive an oxygen-containing stream to regenerate the saturated sulfur absorption material, and the solids pressurizing feeder is configured to substantially reduce or prevent flow of the oxygen-containing stream from the regenerator to the desulfurizer.

8. The system of claim 1, wherein the solids pressurizing feeder comprises at least one of a rotary disk type solids pressurizing feeder, a double-track feeder, or a combination thereof.

9. The system of claim 1, wherein the desulfurizer comprises a first fluidized bed and the regenerator comprises a second fluidized bed.

10. The system of claim 1, comprising a sulfur processor configured to receive the sulfur dioxide from the regenerator to produce elemental sulfur or sulfuric acid.

11. The system of claim 1, comprising an accumulator coupled to the solids pressurizing feeder, wherein the accumulator is configured to store the sulfur absorption material, the saturated sulfur absorption material, or the regenerated sulfur absorption material to be fed to the solids pressurizing feeder.

12. The system of claim 11, wherein the accumulator comprises a cooling coil configured to remove heat from the sulfur absorption material, the saturated sulfur absorption material, or the regenerated sulfur absorption material.

13. The system of claim 1, comprising:
a first separation system coupled to a desulfurizer outlet and configured to separate the saturated sulfur absorption material from the product stream; and
a second separation system coupled to a regenerator outlet and configured to separate the regenerated sulfur absorption material from the sulfur dioxide.

14. The system of claim 13, wherein the first separation system comprises a first cyclone and a first filter, and the second separation system comprises a second cyclone and a second filter.

15. (canceled)

16. A system, comprising:
a first reactor configured to receive a first gaseous stream and generate a first solids stream;
a second reactor configured to receive the first solids stream, receive a second gaseous stream, and generate a second solids stream; and
a solids pressurizing feeder configured to convey the first solids stream or the second solids stream, wherein the solids pressurizing feeder is configured to at least substantially reduce or prevent fluid flow between the first reactor and the second reactor, and wherein the solids pressurizing feeder comprises at least one of a rotary disk type solids pressurizing feeder, a double-track feeder, or a combination thereof.

17. The system of claim 16, wherein the system comprises at least one of a sulfur removal system, a fluid catalytic cracking unit (FCCU), a pressure swing absorption (PSA) system, a temperature swing absorption (TSA) system, or a vacuum swing absorption (VSA) system, or a combination thereof.

18. The system of claim 16, comprising:
a first solids pressurizing feeder configured to convey the first solids stream from the first reactor to the second reactor; and
a second solids pressurizing feeder configured to convey the second solids stream from the second reactor to the first reactor, wherein the first reactor operates at a first pressure, the second reactor operates at a second pressure, and the first and second solids pressurizing feeders at least substantially reduce or prevent fluid flow between the first reactor and the second reactor such that the first and second pressures are different from one another.

19. The system of claim 16, wherein the solids pressurizing feeder is configured to substantially reduce or prevent flow of the first gaseous stream from the first reactor to the second reactor or flow of the second gaseous stream from the second reactor to the first reactor.

20. The system of claim 16, comprising a first solids pressurizing feeder configured to convey the first solids stream to the second reactor and a second solids pressurizing feeder configured to convey the second solids stream to the first reactor.

21. A method, comprising:
receiving a first gaseous stream at a first reactor;
generating a first solids stream at the first reactor;
receiving the first solids stream at a second reactor;
receiving a second gaseous stream at the second reactor;
generating a second solids stream at the second reactor;
conveying the first solids stream or the second solids stream using a solids pressurizing feeder, and
substantially preventing fluid flow between the first reactor and the second reactor using the solids pressurizing feeder.

22. The method of claim 21, comprising:
conveying the first solids stream from the first reactor to the second reactor using a first solids pressurizing feeder;
conveying the second solids stream from the second reactor to the first reactor using a second solids pressurizing feeder;
operating the first reactor at a first pressure;
operating the second reactor at a second pressure; and
substantially preventing fluid flow between the first reactor and the second reactor using the first and second solids pressurizing feeders such that the first and second pressures are different from one another.

23. The method of claim 21, comprising substantially preventing flow of the first gaseous stream from the first reactor to the second reactor using the solids pressurizing feeder or substantially preventing flow of the second gaseous stream from the second reactor to the first reactor using the solids pressurizing feeder.

24. The method of claim 21, comprising conveying the first solids stream to the second reactor using a first solids pressurizing feeder and conveying the second solids stream to the first reactor using a second solids pressurizing feeder.

25. The method of claim 22, comprising directly conveying the first solids stream from the first reactor to the second reactor using the first solids pressurizing feeder, and directly conveying the second solids stream from the second reactor to the first reactor using the second solids pressurizing feeder.
